(19) United States
(12) Patent Application Publication
(10) Pub. No.: US 2022/0113500 A1
(43) Pub. Date: Apr. 14, 2022

(54) OPTICAL LENS GROUP, IMAGING SYSTEM AND WEARABLE DISPLAY DEVICE

(71) Applicant: SZ DJI TECHNOLOGY CO., LTD., Shenzhen (CN)

(72) Inventor: Qing MAO, Shenzhen (CN)

(73) Assignee: SZ DJI TECHNOLOGY CO., LTD., Shenzhen (CN)

(21) Appl. No.: 17/558,597

(22) Filed: Dec. 22, 2021

Related U.S. Application Data
(63) Continuation of application No. PCT/CN2019/092890, filed on Jun. 26, 2019.

(51) Int. Cl. G02B 13/00; G02B 9/10

(52) U.S. Cl. CPC G02B 13/003; G02B 9/10

(57) ABSTRACT

The present discloser relates to an optical lens group. The optical lens group may include a first lens and a second lens arranged coaxially in sequence from an object side to an image side. An object side surface of the first lens may be a flat surface and an image side surface of the first lens may be a concave surface. At least one of an object side surface and an image side surface of the second lens may be a convex surface. The optical lens group may satisfy: 0.75<f/TTL<0.95, wherein f is an effective focal length of the optical lens group, and TTL is a distance from an object surface of the optical lens group to an imaging surface of the optical lens group along an optical axis of the optical lens group.

### CROSS-REFERENCE TO RELATED APPLICATION

The present application is a continuation of International Application No. PCT/CN2019/092890, filed Jun. 26, 2019, the entire contents of which being incorporated herein by reference in its entirety.

### TECHNICAL FIELD

The present disclosure relates to the field of imaging technology, in particular, to an optical lens group, an imaging system, and a wearable display device.

### BACKGROUND

In recent years, with the development of technology, wearable electronic products such as smart VR wearable devices including VR glasses and VR helmets have gradually emerged. Among them, wearable electronic products that are portable and have high-quality imaging quality are more favored by users.

### SUMMARY

One example of the present disclosure provides an optical lens group. The optical lens group may include a first lens and a second lens arranged coaxially in sequence from an object side to an image side. An object side surface of the first lens may be a flat surface and an image side surface of the first lens may be a concave surface. At least one of an object side surface and an image side surface of the second lens may be a convex surface. The optical lens group may satisfy: 0.75<f/TTL<0.95 , wherein f is an effective focal length of the optical lens group, and TTL is a distance from an object surface of the optical lens group to an imaging surface of the optical lens group along an optical axis of the optical lens group.

Another example of the present disclosure provides an imaging system. The imaging system may include a display screen and an optical lens group. The display screen may be arranged on an object surface of the optical lens group. The optical lens group may include a first lens and a second lens arranged coaxially in sequence from an object side to an image side. An object side surface of the first lens may be a flat surface and an image side surface of the first lens may be a concave surface. At least one of an object side surface and an image side surface of the second lens may be a convex surface. The optical lens group may satisfy 0.75<f/TTL<0.95, wherein f is an effective focal length of the optical lens group, and TTL is a distance from an object surface of the optical lens group to an imaging surface of the optical lens group along an optical axis of the optical lens group.

Another example of the present disclosure provides a wearable display device. The wearable display device may include a device body and the imaging system according to one embodiment of the present disclosure. The imaging system may be provided in the device body.

The first lens and the second lens of the optical lens group, the imaging system and the wearable display device provided by some embodiments of the present invention may be arranged in sequence from the object side to the image side. The first lens and the second lens may be arranged coaxially. The object side surface of the first lens may be a flat surface, and the image side surface of the first lens may be a concave surface. At least one of the object side surface of the second lens and the image side surface of the second lens may be a convex surface. Compared with the two sides of each lens constituting the optical lens group are curved surfaces, the object surface of the first lens being a flat surface can reduce the imaging interference at an edge of a display screen, thereby reducing system distortion of the optical lens group, improving imaging quality, and reducing users' eye discomfort and dizziness. In addition, at least one of the object side surface and the image side surface of the second lens is a convex surface, which can converge the light from the first lens to reduce a size of the optical lens group. This arrangement is beneficial to miniaturization design.

### BRIEF DESCRIPTION OF THE DRAWINGS

In order to explain technical features of embodiments of the present disclosure more clearly, drawings used in the present disclosure are briefly introduced as follow. Obviously, the drawings in the following description are some exemplary embodiments of the present disclosure. Ordinary person skilled in the art may obtain other drawings and features based on these disclosed drawings without creative work.

FIG. 1 is a schematic diagram of a structure of an optical lens group when f/TTL=0.79 according to one embodiment of the present disclosure;

FIG. 2 is a chromatic aberration distribution diagram of the optical lens group shown in FIG. 1 according to one embodiment of the present disclosure;

FIG. 3 is a field curvature diagram of the optical lens group shown in FIG. 1 according to one embodiment of the present disclosure;

FIG. 4 is a distortion diagram of the optical lens group shown in FIG. 1 according to one embodiment of the present disclosure;

FIG. 5 is a relative illuminance distribution diagram of the optical lens group shown in FIG. 1 according to one embodiment of the present disclosure;

FIG. 6 is a schematic diagram of a structure of an optical lens group when f/TTL=0.945 according to one embodiment of the present disclosure;

FIG. 7 is a chromatic aberration distribution diagram of the optical lens group shown in FIG. 6 according to one embodiment of the present disclosure;

FIG. 8 is a field curvature diagram of the optical lens group shown in FIG. 6 according to one embodiment of the present disclosure;

FIG. 9 is a distortion diagram of the optical lens group shown in FIG. 6 according to one embodiment of the present disclosure;

FIG. 10 is a relative illuminance distribution diagram of the optical lens group shown in FIG. 6 according to one embodiment of the present disclosure.

### DETAILED DESCRIPTION

In order to make objectives, technical solutions, and advantages of embodiments of the present disclosure clearer, the technical solutions in the embodiments of the present disclosure will be described clearly and completely in conjunction with the accompanying drawings in the embodiments of the present disclosure. Obviously, the described embodiments are part of the embodiments of the present disclosure, rather than all of the embodiments. Based on the embodiments of the present disclosure, all other embodiments obtained by those of ordinary skill in the art without creative work shall fall within protection scope of the present disclosure. In the case of no conflict, the following embodiments and features in the embodiments may be recombined with one another.

As portable electronic products tend to be miniaturized, a total length of the optical system is limited, which increases design difficulty of the optical system. In order to meet requirements of miniaturization, the imaging system of existing products usually has a small image receiver or a small field of view. In addition, the optical system of the existing product has a large distortion, which may result in large picture distortion. The current optical system cannot meet the requirements of miniaturization while achieving large-scale, high-quality imaging effects, thereby causing users having poor immersion experience as well as users' eye discomfort and dizziness.

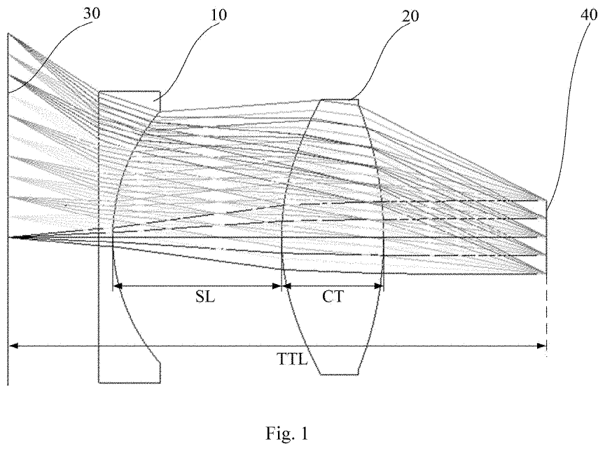

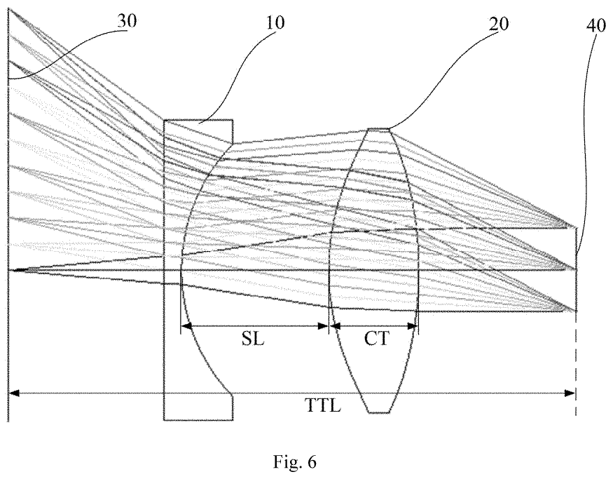

One example of the present disclosure provides an optical lens group. FIGS. 1 and 6 are schematic diagrams of the structure of the optical lens group according to some embodiments of the present disclosure. As shown in FIGS. 1 and 6, the optical lens group may include a first lens 10 and a second lens 20 arranged coaxially from the object side to the image side. The object side surface of the first lens 10 is flat and the image side surface of the first lens 10 is concave. At least one of the object side surface and the image side surface of the second lens 20 is a convex surface. The effective focal length of the optical lens group is f, and the distance from the object surface 30 of the optical lens group to the imaging surface 40 of the optical lens group along its optical axis is TTL. The optical lens group may satisfy:

0.75<f/TTL<0.95

In one embodiment, FIG. 1 is a schematic diagram of the structure of the optical lens group when f/TTL=0.79. FIG. 6 is a schematic diagram of the structure of the optical lens group when f/TTL=0.945. It can be understood that the FTTL of the optical lens group can be arbitrarily selected between 0.75 and 0.95. This embodiment is only an exemplary description and is not limited herein.

In one embodiment, the first lens 10 and the second lens 20 are arranged coaxially. Specifically, the main optical axis of the first lens 10 and the main optical axis of the second lens 20 are arranged collinearly, that is, along a shared optical axis.

Optionally, the image side surface of the first lens 10 is a spherical surface recessed into the first lens 10, that is, the first lens 10 is a concave surface. The main optical axis of the first lens 10 is a straight line perpendicular to the object side surface of the first lens 10 and passing through the spherical center of the image side surface of the first lens 10.

In one embodiment, at least one of the image side surface and the object side surface of the second lens 20 is a convex surface, and at least one of the image side surface and the object side surface of the second lens 20 is a spherical surface convex to the outside of the second lens 20. Exemplarily, the image side surface of the second lens 20 may be a convex surface, and the object side surface of the second lens 20 may be a flat surface. In this case, the main optical axis of the second lens 20 is a straight line perpendicular to the object side surface of the second lens 20 and passing through the spherical center of the image side surface of the second lens 20. Optionally, when the image side surface of the second lens 20 is a convex surface, the object side surface of the second lens 20 may also be a concave surface recessed into the interior of the second lens 20, and the concave surface is a spherical surface. In this case, the main optical axis of the second lens 20 is a straight line passing through the spherical center of the image side surface of the second lens 20 and the spherical center of the object side surface of the second lens 20. In one embodiment, when the image side surface of the second lens 20 is a convex surface, the object side surface of the second lens 20 may also be a convex surface that protrudes outward from the second lens 20, and the convex surface is a spherical surface. In this case, the main optical axis of the second lens 20 is a straight line passing through the spherical center of the image side surface of the second lens 20 and the spherical center of the object side surface of the second lens 20.

Of course, in other embodiments, the object side surface of the second lens 20 can also be set as a convex surface, and the corresponding image side surface of the second lens 20 may be a plane. In this case, the main optical axis of the second lens 20 is a straight line perpendicular to the image side surface of the second lens 20 and passing through the spherical center of the object side surface of the second lens 20. Optionally, when the object side surface of the second lens 20 is a convex surface, the image side surface of the second lens 20 can also be a concave surface that is recessed into the second lens 20, and the concave surface is a spherical surface. In this case, the main optical axis of the second lens 20 is a straight line passing through the spherical center of the image side surface of the second lens 20 and the spherical center of the object side surface of the second lens 20.

In one embodiment, as shown in FIGS. 1 and 6, the image side surface of the second lens 20 and the object side surface of the second lens 20 are both convex surfaces protruding to the outside of the second lens 20. With this arrangement, the light emitted by the first lens 10 is converged toward the main optical axis of the second lens 20 when passing through the object side of the second lens 20 and the image side of the second lens 20. Compared with only the image side surface of the second lens 20 being a convex surface or only the object side surface of the second lens 20 being a convex surface, both the image and object side surfaces of the second lens 20 being convex surfaces can improve ability of the second lens 20 to converge light. As such, the distance between the imaging surface 40 and the second lens 20 is shortened, and the size of the optical lens group is reduced, thereby facilitating realization of miniaturized design.

In some embodiments, the shapes of the first lens 10 and the second lens 20 are not particularly limited. For example, the first lens 10 may have a regular shape such as a circle or a rectangle, or the first lens 10 may have other irregular shapes. Similarly, these embodiments do not limit the shape of the second lens 20. For example, the shape of the second lens 20 may be a regular shape such as a circle or a rectangle, or the second lens 20 may be another irregular shape.

In some embodiments, the object surface 30 of the optical lens group is the position where the light exits. When in use, a display screen or other display device can be set at the object surface 30 of the optical lens group. The imaging surface 40 is a position where the optical lens group receives light from the object surface 30 of the optical lens group and forms an image. Specifically, the display screen located at the object surface 30 of the optical lens emits light, which passes through the first lens 10 and the second lens 20 in turn, and then converges to the imaging surface 40, where the light from the display screen can be received.

In one embodiment, the object surface 30 of the optical lens group is arranged perpendicular to the optical axis of the optical lens group, that is, the object surface 30 of the optical lens group is arranged parallel to the object side surface of the first lens 10. Furthermore, the main optical axis of the first lens 10 and the main optical axis of the second lens 20 are collinear and the optical axis of the optical lens group is collinear with the main optical axis of the first lens 10 and the main optical axis of the second lens 20.

The use process of the optical lens groups provided in these embodiments may include the following: the light from the object surface 30 of the optical lens group is directed to the object side surface of the first lens 10, and the object side surface of the first lens 10 is a flat surface for receiving the light from the object surface 30. After the light enters the object side of the first lens 10, it is emitted from the image side of the first lens 10. The image side of the first lens 10 is a concave surface. As such, compared with an angle between the light incident on the object side of the first lens 10 and its optical axis, the angle between the light emitted through the image side surface of the first lens 10 and its optical axis is reduced so as to collect the light received from the object surface 30. In one embodiment, after being processed by the first lens 10, the light is emitted from the image side surface of the first lens 10 in a direction substantially parallel to its optical axis and is directed toward the second lens 20. In this embodiment, the object side surface of the first lens 10 is a flat surface, and the image side surface thereof is a concave surface. The light on the display screen can be collected in a short stroke, which is conducive to miniaturization. On the other hand, under the premise that the distance of the optical lens group along the optical axis direction is constant, in one embodiment, the display screen can be set to be larger, thereby realizing large-scale imaging and improving the immersion experience of the users. Further, the light from the first lens 10 enters from the object side of the second lens 20 and exits through the image side of the second lens 20. Since at least one of the object side surface of the second lens 20 and the image side surface of the second lens 20 is a convex surface that protrudes outward from the second lens 20, the convex surface can converge light, so that the light emitted by the second lens 20 converges on the imaging surface 40 of the optical lens group so as to realize imaging of the optical lens group.

Optionally, when the image side surface of the second lens 20 and the object side surface of the second lens 20 are both convex, the light passing through the second lens 20 can be converged twice, thereby improving the light converging ability and reducing the distance between the imaging surface 40 of the optical lens group and the second lens 20. As such, the distance between the imaging surface 40 of the optical lens group and the object surface 30 of the optical lens group along the optical axis direction is reduced. Compared with only the image side surface of the second lens 20 or the object side surface of the second lens 20 being a convex surface, the size of the optical lens group can be reduced, which is beneficial to miniaturized design.

In the optical lens group provided by some embodiment of the present disclosure, the first lens 10 and the second lens 20 are arranged in sequence from the object side to the image side, and the first lens 10 and the second lens 20 are arranged coaxially. The object side of the first lens 10 is a plane, and the image side surface of the first lens 10 is a concave surface. At least one of the object side surface of the second lens 20 and the image side surface of the second lens 20 is a convex surface. Compared with both sides of each lens constituting the optical lens group are curved surfaces, the object surface 30 of the first lens 10 being a flat surface can reduce the imaging interference at the edge of the display screen, thereby reducing the system distortion of the optical lens group, improving the imaging quality, and reducing users' eye discomfort and dizziness. In addition, at least one of the object side surface and the image side surface of the second lens 20 is a convex surface, which can converge the light from the first lens 10 to reduce the size of the optical lens group, which is conducive to miniaturization design.

These embodiments do not limit the material constituting the first lens 10. For example, the first lens 10 may be mainly composed of materials such as glass and resin. In one embodiment, the material of the first lens 10 is glass, wherein the refractive index of the glass is higher than the refractive index of the resin. In this way, the first lens 10 with high refractive index is beneficial to slow down the emerging angle of the object surface, better realize light collection, improve the imaging quality of the corners, and thus realize the miniaturization design. In addition, the high processing precision of the glass makes the optical lens group less sensitive to tolerances and more stable in performance.

In one embodiment, the refractive index of the first lens 10 is n₁, and the refractive index of the first lens 10 satisfies: 1.7≤n₁1.9. This arrangement ensures that the first lens 10 has a high refractive index, thereby improving the divergence ability of the first lens 10, and further reducing the angle between the light emitted by the first lens 10 and the optical axis. As such, the light emitted by the first lens 10 is directed toward the second lens 20 in a direction substantially parallel to the optical axis.

In one embodiment, the material of the second lens 20 is plastic. The second lens 20 made of plastic is inexpensive to process and simple to manufacture.

In one embodiment, a half-diameter of the second lens 20 is DA, a thickness of the second lens 20 on the optical axis is CT , a radius of curvature of the object side of the second lens 20 is R₁, a radius of curvature of the image side of the second lens 20 is R₂. In this embodiment, the second lens 20 satisfies: 1.0≤DA/CT≤1.5 and 0.5<|Rₗ/R₂|<0.8 .

This arrangement can reduce the distortion of the image formed by the optical lens group and the volume of the second lens 20, thereby reducing the size of the optical lens group.

In this embodiment, a diameter of the second lens 20 is a diameter of a circular cross-section having the largest area among cross-sections of the second lens 20 perpendicular to the optical axis direction. The corresponding half-diameter of the second lens 20 is a radius of the circular cross-section having the largest area among the cross-sections of the second lens 20 perpendicular to the optical axis direction.

In one embodiment, when the object side surface of the second lens 20 is convex, R₁ is a positive value. When the object side surface of the second lens 20 is a concave surface, R₁ is a negative value. When the object side surface of the second lens 20 is flat, R₁ is 0. Similarly, when the image side surface of the second lens 20 is convex, R₂ is a positive value. When the image side surface of the second lens 20 is a concave surface, R₂ is a negative value. When the image side surface of the second lens 20 is a flat surface, R₂ is 0. To ensure 0.5<|R₁/R₂<0.8, the image side surface of the second lens 20 and the object side surface of the second lens 20 are not flat.

In one embodiment, the refractive index of the second lens 20 is n₂, the dispersion value of the second lens 20 is VD, and the second lens 20 also satisfies:1.5≤n₂≤1.56 and 54≤VD≤57 . Since light has a certain degree of dispersion after passing through the first lens 10, the second lens 20 can process the dispersed light from the first lens 10, thereby reducing the degree of dispersion of the light after passing through the optical lens group, correcting the chromatic aberration of the optical lens group, and improving the imaging effect of the optical lens group.

Further, in one embodiment, the first lens 10 is a negative lens, and the second lens 20 is a positive lens.

In one embodiment, a distance between a center vertex of the image side surface of the first lens 10 and a center vertex of the object side surface of the second lens 20 on the optical axis is SL . The distance from the object surface 30 of the optical lens group to the imaging surface 40 of the optical lens group on the optical axis is TTL , and the optical lens group also satisfies: 0.1<SL/TTL<0.5. With this arrangement, the size of the optical lens group can be further reduced.

The center vertex of the image side surface of the first lens 10 may be an intersection point of the optical axis and the image side surface of the first lens 10, and the center vertex of the object side surface of the second lens 20 may be an intersection point of the optical axis and the object side surface of the second lens 20.

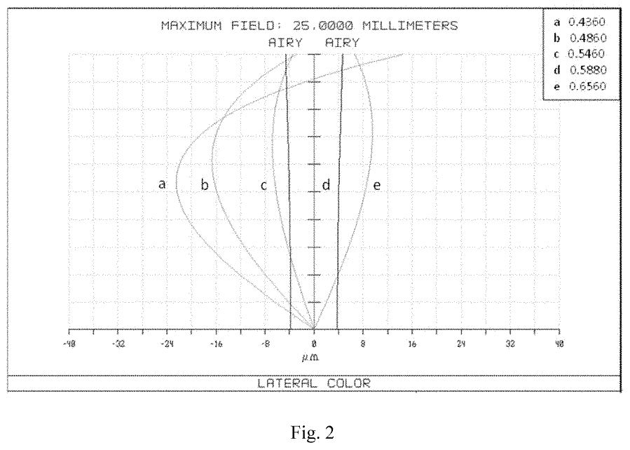

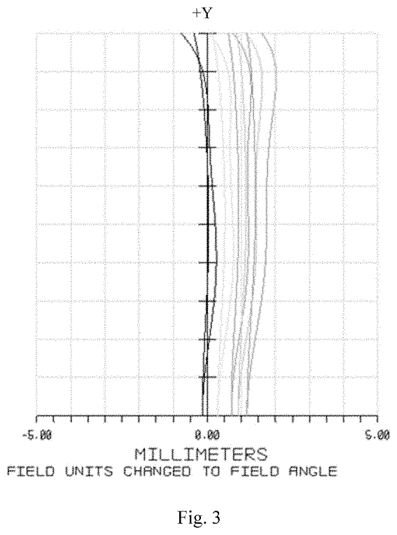

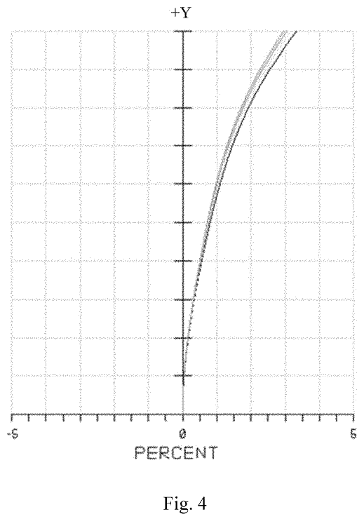

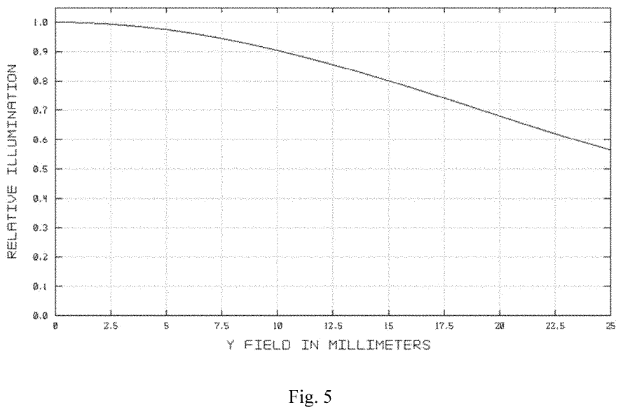

FIG. 1 is a schematic diagram of the structure of the optical lens group when f/TTL=0.79. FIG. 2 is a chromatic aberration distribution diagram of the optical lens group shown in FIG. 1. FIG. 3 is a field curvature diagram of the optical lens group shown in FIG. 1. FIG. 4 is a distortion diagram of the optical lens group shown in FIG. 1. FIG. 5 is a relative illuminance distribution diagram of the optical lens group shown in FIG. 1.

Further, Tables 1-3 show main optical performance parameters of the optical lens group shown in FIG. 1.

TABLE 1
Data of each surface of the optical lens group

| | Surface | | | | |
|---|---|---|---|---|---|
| | # | R | D | ND | VD |
| light Source (OBJ) | | Infinity | 11.12548 | | |
| | 1 | Infinity | 1.699475 | 1.785 | 25.72 |
| | 2 | 23.38734 | 20.69772 | | |
| | 3 | 28.2145 | 12.50001 | 1.53 | 55.8 |
| | 4 | −43.57993 | 20 | | |
| Aperture Stop | 5 | Infinity | −1000 | | |
| (STO) | | | | | |
| Image (IMA) | 6 | Infinity | | | |

The first surface is the object side surface of the first lens, the second surface is the image side surface of the first lens, the third surface is the object side surface of the second lens, and the fourth surface is the image side surface of the second lens. The aperture stop (STO) is a screen for receiving. In this embodiment, the image (IMA) is formed on the aperture stop (STO), that is, the 5th surface and the 6th surface can overlap.

TABLE 2
Focal length and distribution capacity of each lens

| lens | Focal length | Distribution capacity |
|---|---|---|
| First lens | −29.81 | −0.03354579 |
| Second lens | 34.32 | 0.029137529 |

Correspondingly, the viewing angle of the optical lens group in this embodiment is 54°, and the optical distortion is 3.00%.

TABLE 3
Aspheric data

| | K | A2 | A4 | A6 | A8 | A10 | A12 | A14 | A16 |
|---|---|---|---|---|---|---|---|---|---|
| Surface | −7.27028 | 0 | 3.27774E−05 | −9.19969E−08 | 1.01262E−10 | 0 | 0 | 0 | 0 |
| 3 (object | | | | | | | | | |
| side of | | | | | | | | | |
| the | | | | | | | | | |
| second | | | | | | | | | |
| lens) | | | | | | | | | |
| Surface | −5.07593 | 0 | −2.02258E−06 | −2.73267E−08 | 4.86717E−11 | 0 | 0 | 0 | 0 |
| 4 (image | | | | | | | | | |
| side of | | | | | | | | | |
| the | | | | | | | | | |
| second | | | | | | | | | |
| lens) | | | | | | | | | |

Among them, A2-A16 represent the second to 16th order aspheric coefficients of the object side surface or the image side surface of the second lens, and K is the conic coefficient.

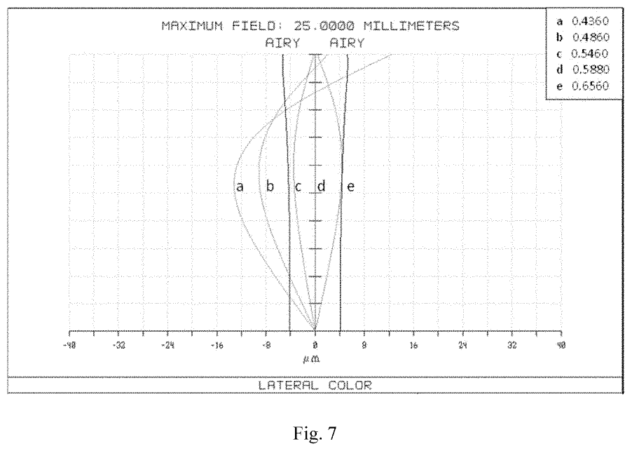

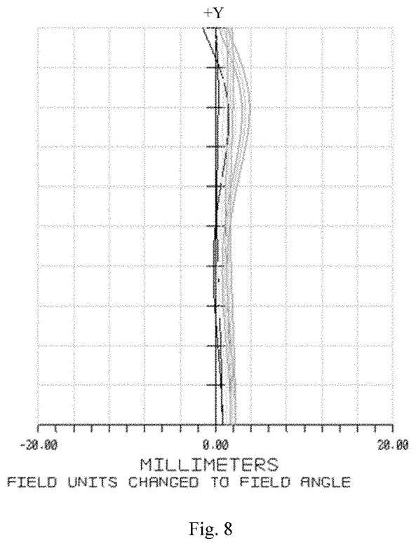

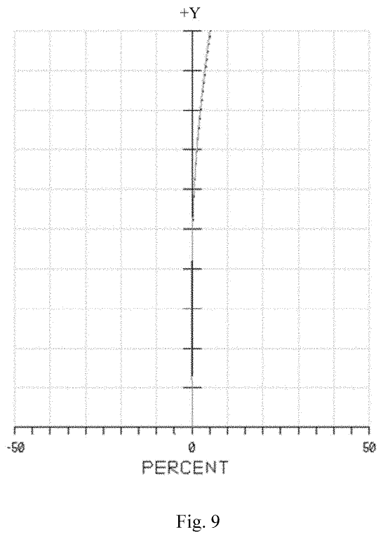

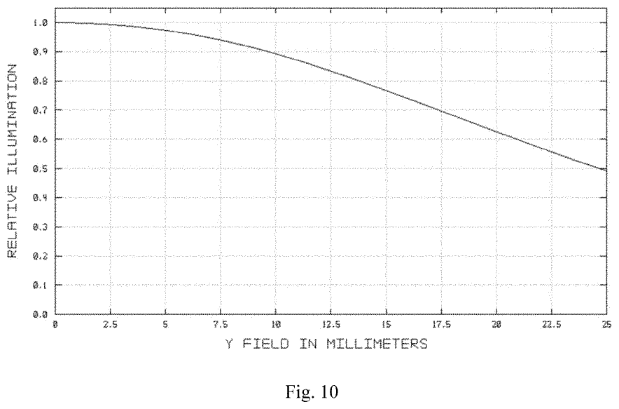

In another implementations, FIG. 6 is a schematic diagram of the structure of the optical lens group when f/TTL=0.945. FIG. 7 is a chromatic aberration distribution diagram of the optical lens group shown in FIG. 6. FIG. 8 is a field curvature diagram of the optical lens group shown in FIG. 6. FIG. 9 is a distortion diagram of the optical lens group shown in FIG. 6. FIG. 10 is a relative illuminance distribution diagram of the optical lens group shown in FIG. 6.

Further, Table 4-6 shows the main optical performance parameters of the optical lens group shown in FIG. 2.

TABLE 4
Data of each surface of the optical lens group

| | Surface | | | | |
|---|---|---|---|---|---|
| | # | R | D | ND | VD |
| Light source (OBJ) | | Infinity | 14.776 | | |
| | 1 | Infinity | 1.699475 | 1.8 | 35 |
| | 2 | 17.228 | 13.993 | | |
| | 3 | 23.715 | 8.563 | 1.53 | 55.8 |
| | 4 | −33.23 | 16 | | |
| Aperture Stop | 5 | Infinity | −1000 | | |
| (STO) | | | | | |
| Image (IMA) | 6 | Infinity | | | |

Among them, the first surface is the object side surface of the first lens, the second surface is the image side surface of the first lens, the third surface is the object side surface of the second lens, and the fourth surface is the image side surface of the second lens. The aperture stop (STO) is a screen for receiving. In this embodiment, the image (IMA) is formed on the aperture stop (STO), that is, the 5th surface and the 6th surface can overlap.

TABLE 5
Focal length and distribution capacity of each lens

| Lens | Focal length | Distribution capacity |
|---|---|---|
| First Lens | −21.51 | −0.04649 |
| Second Lens | 26.84 | 0.0372578 |

Correspondingly, the viewing angle of the optical lens group in this embodiment is 55°, and the optical distortion is 5.00%.

TABLE 6
Aspheric data

| | K | A2 | A4 | A6 | A8 | A10 | A12 | A14 | A16 |
|---|---|---|---|---|---|---|---|---|---|
| Surface | −0.808 | 0 | 3.10E−05 | −4.42E−07 | 2.53E−09 | −6.39E−12 | 0 | 0 | 0 |
| 3 (object | | | | | | | | | |
| side of | | | | | | | | | |
| the | | | | | | | | | |
| second | | | | | | | | | |
| lens) | | | | | | | | | |
| Surface | −6.597 | 0 | 6.08E−06 | −3.23E-07 | 1.96E−09 | −496E−12 | 0 | 0 | 0 |
| 4 (image | | | | | | | | | |
| side of | | | | | | | | | |
| the | | | | | | | | | |
| second | | | | | | | | | |
| lens) | | | | | | | | | |

Among them, A2-A16 represent the second to 16th order aspheric coefficients of the object side surface or the image side surface of the second lens, and K is the conic coefficient.

As shown in FIG. 1, another example of the present disclosure provides an imaging system, including: a display screen and an optical lens group. The display screen may be arranged on the object surface 30 of the optical lens group. The optical lens group may include a first lens 10 and a second lens 20 coaxially arranged in sequence from the object side to the image side. The object side surface of the first lens 10 may be flat and the image side surface thereof may be concave. At least one of the object side surface and the image side surface of the second lens 20 may be convex. The effective focal length of the optical lens group is f. The distance from the object surface 30 of the optical lens group to the imaging surface 40 of the optical lens group on the optical axis is TTL, and the optical lens group satisfies:

0.75<f/TTL<0.95.

In one embodiment, the display screen arranged on the object surface 30 of the optical lens group is used as the light source of the imaging system. After the image displayed on the display screen passes through the first lens 10 and the second lens 20 of the optical lens group, the image will be formed on the imaging surface 40 of the optical lens group, and the user can receive the image at the imaging surface 40.

The optical lens group in this embodiment is substantially the same as the optical lens group in the previous embodiments. The optical lens group of this embodiment can be described with reference to the previous embodiments, and details thereof are not repeated here.

In the imaging system provided by some embodiments of the present disclosure, the first lens 10 and the second lens 20 are arranged in sequence from the object side to the image side, and the first lens 10 and the second lens 20 are arranged coaxially. The object side of the first lens 10 is a flat surface, and the image side of the first lens 10 is a concave surface. At least one of the object side surface of the second lens 20 and the image side surface of the second lens 20 is a convex surface. Compared with the two sides of each lens constituting the optical lens group are curved, the object surface 30 of the first lens 10 being flat may reduce the imaging interference at the edge of the display screen, thereby reducing the system distortion of the optical lens group, improving the image quality, and reducing users' eye discomfort and dizziness. In addition, at least one of the object side surface and the image side surface of the second lens 20 is a convex surface, which can converge the light from the first lens 10 to reduce the size of the optical lens group, which is beneficial to the miniaturization design.

Another example of the present disclosure provides a wearable display device, including a device body and the imaging system as described above according to one embodiment of the present disclosure, which will not be repeated here. Among them, the imaging system is set in the device body.

The wearable display device in this embodiment may be a virtual reality head-mounted display device such as VR glasses, VR helmets, and so on.

In the description of the present disclosure, it should be understood that the terms “center,” “longitudinal,” “transverse,” “length,” “width,” “thickness,” “upper,” “lower,” “front,” “ back,” “left,” “right,” “vertical,” “horizontal,” “top,” “bottom,” “inner,” “outer,” “clockwise,” “counterclockwise,” “axial,” “radial,” “circumferential,” etc. indicate orientation or positional relationship based on the orientation or positional relationship shown in the drawings, and are only for the convenience of describing the present disclosure and simplifying the description, and do not indicate or imply that the referred device or element must have a specific orientation, be constructed and operated in a specific orientation, and therefore cannot be understood as a limitation of the present disclosure.

It should be noted that in the description of the present disclosure, the terms “first” and “second” are only used to facilitate description of different components and cannot be understood as indicating or implying the order relationship, relative importance or implicitly indicating the quantity of the indicated technical characteristics. Therefore, the features defined with “first” and “second” may explicitly or implicitly include at least one of the features.

In the present disclosure, unless expressly specified otherwise, the terms “installed,” “connected,” “coupled,” “fixed” and other terms should be interpreted broadly. For example, it may be a fixed connection or a detachable connection, or integrally formed, which can be mechanically connected, or electrically connected, or can communicate with each other. It can be directly connected or indirectly connected through an intermediate medium, and it can be the internal communication between two components or the interaction between the two components, unless there are other clear restrictions. For those of ordinary skill in the art, the specific meaning of the above-mentioned terms in the present disclosure can be understood according to specific circumstances.

Finally, it should be noted that the above embodiments are only used to illustrate the technical solutions of the present disclosure, not to limit them; although the present disclosure has been described in detail with reference to the foregoing embodiments, those of ordinary skill in the art should understand that the technical solutions recorded in the foregoing embodiments can still be modified, or some or all of the technical features can be equivalently replaced. However, these modifications or replacements do not cause the essence of the corresponding technical solutions to deviate from the scope of the technical solutions of the embodiments of the present disclosure.

### DESCRIPTION OF REFERENCE NUMBERS

10: The first lens;

20: the second lens;

30: Object surface;

40: Imaging surface.

What is claimed is:

1. An optical lens group, comprising:
a first lens and a second lens arranged coaxially in sequence from an object side to an image side;
an object side surface of the first lens is a flat surface and an image side surface of the first lens is a concave surface;
at least one of an object side surface and an image side surface of the second lens is a convex surface; and
the optical lens group satisfies 0.75<f/TTL<0.95;
wherein f is an effective focal length of the optical lens group, and TTL is a distance from an object surface of the optical lens group to an imaging surface of the optical lens group along an optical axis of the optical lens group.

2. The optical lens group of claim 1, wherein the image side surface of the second lens is the convex surface.

3. The optical lens group of claim 1, wherein both the object side surface and the image side surface of the second lens are convex surfaces.

4. The optical lens group of claim 1, wherein material of the first lens comprises glass.

5. The optical lens group of claim 4, wherein a refractive index of the first lens is n₁, which satisfies 1.7≤n₁≤1.9.

6. The optical lens group of claim 1, wherein material of the second lens comprises plastic.

7. The optical lens group of claim 6, wherein the second lens satisfies:
1.0≤DA/CT≤1.5 and 0.5<|R₁/R₂|<0.8
wherein DA is a half-diameter of the second lens, CT is a thickness of the second lens along its optical axis, R₁ is a radius of curvature of the object side of the second lens, and R₂ is a radius of curvature of the image side surface of the second lens.

8. The optical lens group of claim 7, wherein the second lens further satisfies:
1.5≤n₂≤1.56 and 54≤VD≤57
wherein n₂ is a refractive index of the second lens, and VD is a dispersion value of the second lens.

9. The optical lens group of claim 1, wherein the first lens is a negative lens.

10. The optical lens group of claim 1, wherein the second lens is a positive lens.

11. The optical lens group of claim 1, wherein the optical lens group satisfies:
0.1<SL/TTL<0.5
wherein SL is a distance between a center vertex of the image side surface of the first lens and a center vertex of the object side surface of the second lens along its optical axis.

12. An imaging system, comprising:
a display screen and an optical lens group, the display screen being arranged on an object surface of the optical lens group,
wherein the optical lens group comprises a first lens and a second lens arranged coaxially in sequence from an object side to an image side;
an object side surface of the first lens is a flat surface and an image side surface of the first lens is a concave surface;
at least one of an object side surface and an image side surface of the second lens is a convex surface; and
the optical lens group satisfies 0.75<f/TTL<0.95 ;
wherein f is an effective focal length of the optical lens group, and TTL is a distance from an object surface of the optical lens group to an imaging surface of the optical lens group along an optical axis of the optical lens group.

13. The imaging system of claim 12, wherein the image side surface of the second lens is the convex surface.

14. The imaging system of claim 12, wherein both the object side surface and the image side surface of the second lens are convex surfaces.

15. The imaging system of claim 12, wherein material of the first lens comprises glass.

16. The imaging system of claim 15, wherein a refractive index of the first lens is n₁, which satisfies 1.7≤n₁≤1.9.

17. The imaging system of claim 12, wherein material of the second lens comprises plastic.

18. The imaging system of claim 17, wherein the second lens satisfies:
1.0≤DA/CT≤1.5 and 0.5<|R₁/R₂|<0.8
wherein DA is a half-diameter of the second lens, CT is a thickness of the second lens along its optical axis, R₁ is a radius of curvature of the object side of the second lens, and R₂ is a radius of curvature of the image side surface of the second lens.

19. The imaging system of claim 18, wherein the second lens further satisfies:
1.5≤n₂≤1.56 and 54≤VD≤57
wherein n₂ is a refractive index of the second lens, and VD is a dispersion value of the second lens

20. A wearable display device, comprising a device body and the imaging system according to claim 12, the imaging system being provided in the device body.
